(19) United States
(12) Patent Application Publication
(10) Pub. No.: US 2006/0244429 A1
(43) Pub. Date: Nov. 2, 2006

(54) Free wheeling MOSFET control circuit for pre-biased loads

(75) Inventor: Astros M. Quitayen, Londonderry, NH (US)

Correspondence Address: HARNESS, DICKEY & PIERCE, P.L.C., P.O. BOX 828, BLOOMFIELD HILLS, MI, 48303, US

(73) Assignee: Astec International Limited, Kwun Tong (HK)

(21) Appl. No.: 11/116,762

(22) Filed: Apr. 28, 2005

(51) Int. Cl. G05F 1/00

(52) U.S. Cl. 323/222

(57) ABSTRACT

A circuit controls a control signal of a free-wheeling switch and has a switch in series with the control signal signal. A timer has an output that controls the switch. The timer opens the switch for a predetermined time and closes the switch afterwards. In other embodiments, a free-wheeling switch circuit is provided for a synchronous switching power supply having an input and a pre-biased output. The switch circuit has an inductor, a first switch connected to the inductor and having a first control input, a first control signal source, a second switch having a second control input and being connected between the first control signal source and the first control input, and a control circuit having an output in communication with the second control input. The control circuit opens the second switch for a predetermined time and then closes the second switch.

### FIELD OF THE INVENTION

The present invention relates generally to electrical power supply circuits, and more particularly to circuits for controlling a turn-on rate of a free wheeling switch.

### BACKGROUND OF THE INVENTION

Some power supply circuits have outputs connected to pre-biased loads. A pre-biased load is one which has a supply voltage applied to it even the load and the power supply circuit are otherwise turned off. An example of such a load is a microprocessor having battery-backed static RAM.

In synchronous rectifier power supplies, it is known to use MOSFETs that have a high gate-source threshold voltage to avoid causing transient perturbations of the supply voltage when first turning on the power supply circuit. However, such MOSFETs are undesirably inefficient when used in power supply circuits that provide a low supply voltage with high current. In such applications, it is desirable to use MOSFETs having a lowest possible drain-source resistance, Rds(on), to improve an energy efficiency of the power supplies. However, MOSFETs having a low Rds(on) also tend to have a low gate-source threshold voltage that contributes to the transient perturbations associated with pre-biased loads.

### SUMMARY OF THE INVENTION

In accordance with these needs in the art, a circuit controls a control signal of a free-wheeling switch has a switch in series with the control signal. A timer has an output that controls the switch. The timer opens the switch for a predetermined time and closes the switch afterwards.

In other embodiments, a free-wheeling switch circuit is provided for a synchronous switching power supply having an input and a pre-biased output. The switch circuit has an inductor, a first switch connected to the inductor and having a first control input, a first control signal source, a second switch having a second control input and being connected between the first control signal source and the first control input, and a control circuit having an output in communication with the second control input of the second switch. The control circuit opens the second switch for a predetermined time after applying power to the input of the power supply and closes the switch after the predetermined time.

Also provided is a method for driving a gate of a free-wheeling switch in a switching power supply. The method generates a control signal and operates the free-wheeling switch in a first mode when the control signal turns on the free-wheeling switch during a predetermined period. The method also operates the free-wheeling switch in a second mode when the gate signal turns on the free-wheeling switch after the predetermined period.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a schematic diagram of DC-DC converter having a gate control circuit for a free-wheeling switch;

FIG. 2 depicts a schematic diagram of a DC-DC buck converter having a gate control circuit for a free-wheeling switch;

FIG. 3 depicts a timing diagram of the gate control circuits of FIGS. 1-2; and

FIG. 4 depicts a functional block diagram of a DC-DC converter having a gate control circuit for a free-wheeling switch.

### DETAILED DESCRIPTION OF THE PREFERRED EMBODIMENTS

The following description is merely exemplary in nature and is in no way intended to limit the invention, its application, or uses. Throughout this specification, like reference numerals will refer to similar elements.

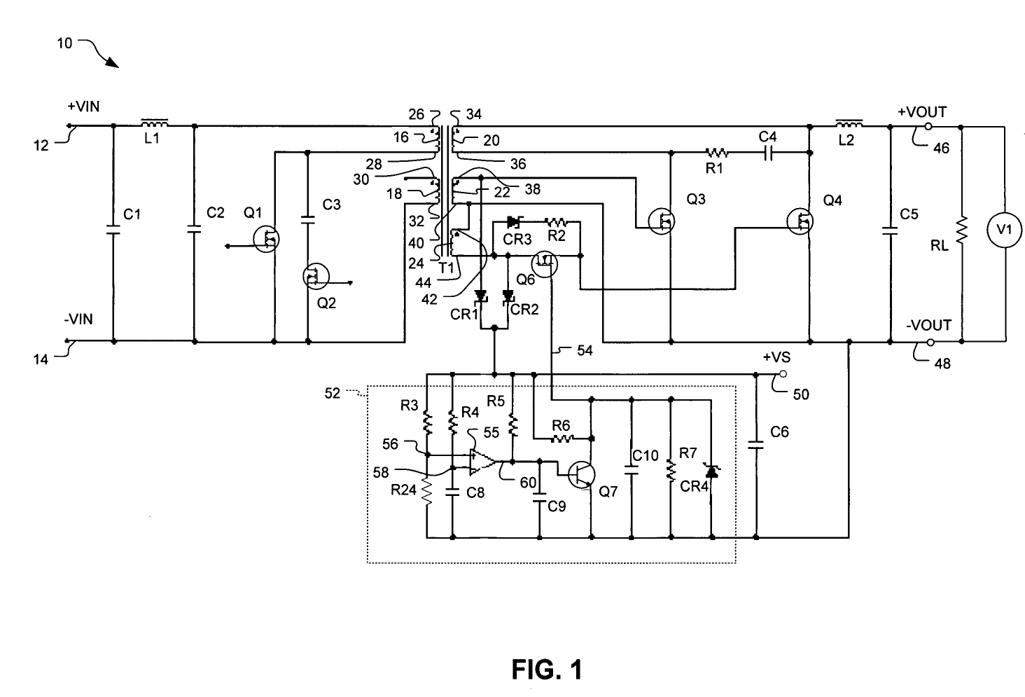

FIG. 1 shows one of various embodiments of a synchronous DC-DC converter 10. A +VIN 12 terminal and a −VIN 14 terminal provide an input to the converter 10. A capacitor C1 is connected across the +VIN 12 and −VIN 14 terminals. An inductor L1 has one end connected to the +VIN 12 terminal. A capacitor C2 is connected across the other end of the inductor L1 and the −VIN terminal 14. A transformer T1 has a first primary winding 16, a second primary winding 18, a secondary winding 20, a first auxiliary winding 22, and a second auxiliary winding 24. The first primary winding 16 has a first terminal 26 and a second terminal 28. The second primary winding 18 has a first terminal 30 and a second terminal 32. The secondary winding 20 has a first terminal 34 and a second terminal 36. The first auxiliary winding 22 has a first terminal 38 and a second terminal 40. The second auxiliary winding 24 has a first terminal 42 and a second terminal 44.

The junction of the inductor L1 and the capacitor C2 is connected to the first terminal 26 of the first primary winding 16. The second terminal 28 of the first primary winding is connected to a drain of a transistor switch Q1 and to one end of a capacitor C3. A source of the transistor switch Q1 is connected to −VIN 14. The other end of the capacitor C3 is connected to a drain of a transistor switch Q2. A source of the transistor switch Q2 is connected to −VIN 14. A gate of the transistor switch Q1 receives a first control signal and a gate of the transistor switch Q2 receives a second control signal. The first control signal is preferably a PWM waveform and the second control signal is substantially a complement of the first control signal. A primary bias voltage is provided at the first terminal 30 of the second primary winding. The second terminal 32 of the second primary winding is connected to −VIN 14.

On the secondary side of the transformer T1, the first terminal 34 of the secondary winding 20 is connected to a drain of a free-wheeling switch Q4, one end of a capacitor C4, and one end of an inductor L2. The other end of the inductor L2 is connected to one end of a capacitor C5 and a +VOUT 46. The +VOUT 46 is pre-biased to an output voltage by an external voltage source V1 connected between the +VOUT 46 and a −VOUT node 48. The other end of the capacitor C5 is connected to the −VOUT 48. A source of the free-wheeling switch Q4 is connected to the −VOUT 48. The other end of the capacitor C4 is connected to one end of a resistor R1. The other end of the resistor R1 is connected to the second terminal 36 of the secondary winding 20 and to a drain of a transistor switch Q3.

A source of the transistor switch Q3 is connected to the −VOUT 48 and to the second terminal 40 of the first auxiliary winding 22. A gate of the transistor switch Q3 is connected to the first terminal 38 of the first auxiliary winding 22. The second terminal 40 of the first auxiliary winding is connected to the first terminal 42 of the second auxiliary winding 24. The second terminal 44 of the second auxiliary winding 24 is connected to an anode of a rectifier CR3, to an anode of a rectifier CR2, and to a drain of a transistor switch Q6. A cathode of the rectifier CR3 is connected to one end of a resistor R2. The other end of the resistor R2 is connected to a source of the transistor switch Q6 and to a gate of the free-wheeling switch Q4. The first terminal 38 of the first auxiliary winding 22 is connected to an anode of a rectifier CR1. A cathode of the rectifier CR1 and a cathode of the rectifier CR2 are connected to one end of a capacitor C6. The capacitor C6 provides a secondary bias voltage +VS 50 and has a second end connected to −VOUT 48.

The secondary bias voltage +VS 50 provides power for a gate control circuit 52 that generates a gate control signal 54. The gate control signal 54 is connected to a gate of the transistor switch Q6. One end of a resistor R3 is connected to +VS 50. The other end of the resistor R3 is connected to −VOUT 48 through a resistor R24. One end of a resistor R4 is connected to +VS 50. The other end of the resistor R4 is connected to −VOUT 48 through a capacitor C8. A comparator 55 has a non-inverting input 56 connected to the junction of the resistor R3 and the resistor R24. An inverting input 58 of the comparator 55 is connected to the junction of the resistor R4 and the capacitor C8. An output 60 of the comparator 55 is pulled up to +VS 50 by a resistor R5. The output 60 is also connected to a base of a transistor switch 07 and to one end of a capacitor C9. The other end of the capacitor C9 is connected to −VOUT 48. A collector of the transistor switch Q7 provides the gate control signal 54 and is pulled up to +VS 50 by a resistor R6. An emitter of the transistor switch Q7 is connected to −VOUT 48. A capacitor C10, a resistor R7, and a zener diode CR4 are connected in parallel between the gate control signal 54 and −VOUT 48.

Operation of the circuit of FIG. 1 will now be described. A PI filter is formed by the capacitors C1 and C2, and the inductor L1. The PI filter provides a filtered voltage to the first terminal 26 of the primary winding 16. The switching transistors Q1 and Q2 switch on and off in accordance with the first and second control signals applied to their respective gates, establishing a pulsed current through the primary winding 16. A period when the switching transistor Q1 is turned on will be referred to as the positive period and a period when the transistor Q2 is turned on will be referred to as the negative period. The pulsed current in the primary winding 16 causes voltage pulses to appear at the secondary winding 20, the first auxiliary winding 22, and the second auxiliary winding 24. The pulsed voltages are in phase with the primary winding 16 as indicated by a phase dot shown at the first terminal 26, 30, 34, 38, and 42 of each winding 16,18, 20, 22, and 24.

During the positive period, the first terminal 38 of the first auxiliary winding 22 turns on the transistor switch Q3. This allows current to flow from the first terminal 34 of the secondary winding 20 thru the inductor L2, and through a load R_{L} connected to +VOUT 46. The free-wheeling switch Q4 is turned off during the positive period by the second terminal 44 of the second auxiliary winding 24. The gate of the free-wheeling switch Q4 quickly discharges through a body diode inherent in the transistor switch Q6. In other embodiments, a fast rectifier, such as a Schottkey diode, may be connected across the transistor switch Q6 to quickly discharge the gate of the free-wheeling switch 04. The fast rectifier can have an anode connected to the drain of the transistor switch Q6. The capacitor C6 is charged through the rectifier CR1 during the positive period, thereby providing a portion of the charge for secondary bias voltage at +VS50.

During the negative period, the first terminal 38 of the first auxiliary winding 22 turns off the transistor switch Q3. The inductor L2 discharges through the capacitor C5 and provides a portion of the charge for +VOUT 46 when the transistor switch Q3 turns off. For a predetermined period after application of +VIN, the switching transistor Q6 is turned off the by the gate control signal 54 as described later. During the negative periods that occur during the predetermined period, the free-wheeling switch Q4 is partially turned on by a positive voltage appearing at the second terminal 42 of second auxiliary winding 22. The free-wheeling switch Q4 is only partially turned on since the resistor R2 limits current for charging the gate of the free-wheeling switch Q4. The first and second auxiliary windings 22, 24 are connected in series and provide a positive gate voltage for the free-wheeling switch Q4. After the predetermined period, the gate control signal 54 turns on the transistor switch Q6, allowing the free-wheeling switch Q4 to be saturated during the negative period.

Transient perturbations of +VOUT 46 are prevented during the predetermined period since the free-wheeling switch Q4 is not saturated and undesirably providing a short circuit to −VOUT 48 through the inductor L2. Also during the negative period, the capacitor C6 is charged through the rectifier CR2 to provide a remainder of the charge for the secondary bias voltage at +VS 50.

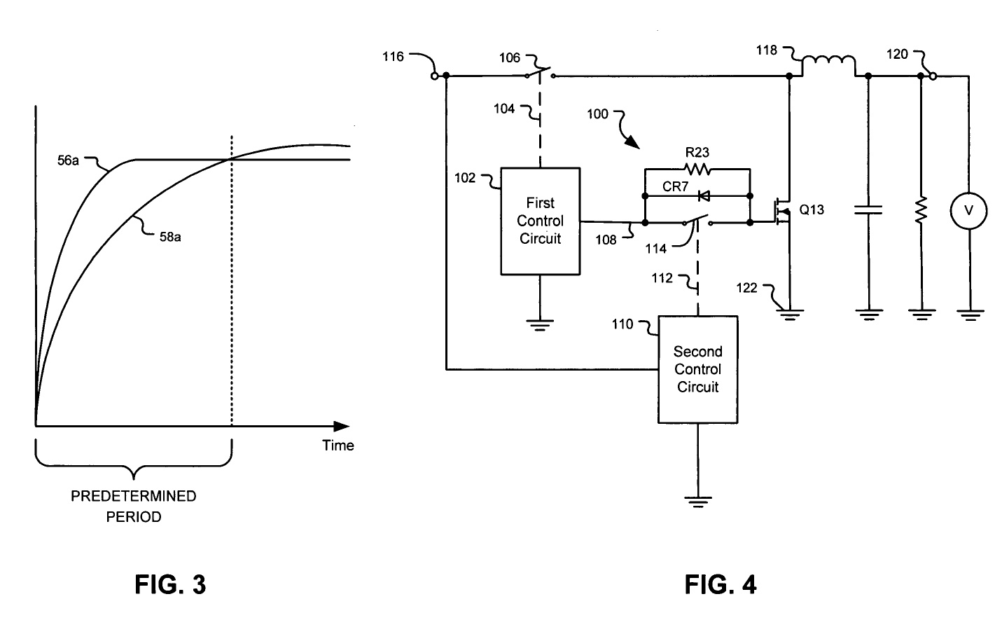

Operation of the gate control circuit 52 will be now be described. The resistors R3, R4, R24, and the capacitor C8 establish the predetermined period. The resistors R3 and R24 form a voltage divider providing a first signal 56a (FIG. 3) to the non-inverting input 56 of the comparator 55. The resistor R4 and the capacitor C8 form an RC timer providing a second signal 58a (FIG. 3) to the inverting input 58 of the comparator 55. Values of the resistors R3, R4, R24, and the capacitor C8 are chosen such that the intersection of the first and second signals 56a and 58a occurs at the expiration of the predetermined period.

During the predetermined period after application of +VIN, the voltage of the non-inverting input 56 exceeds the voltage of the inverting input 58 and causes the output 60 of the comparator 55 to be high. With the output 60 high, the transistor switch Q7 is turned on and pulling the gate of the transistor switch Q6 down to −VOUT 48, turning the transistor switch Q6 off. After the predetermined period, the voltage of the inverting input 58 exceeds the voltage of the non-inverting input 56 and causes the output 60 of the comparator 55 to go low and turn the transistor switch Q7 off. The gate of the transistor switch Q6 is then pulled up through the resistor R6 to +VS 50, which turns the transistor switch Q6 on. The free-wheeling switch Q4 therefore operates efficiently after the predetermined period since its gate may be quickly charged and discharged through the transistor switch Q6.

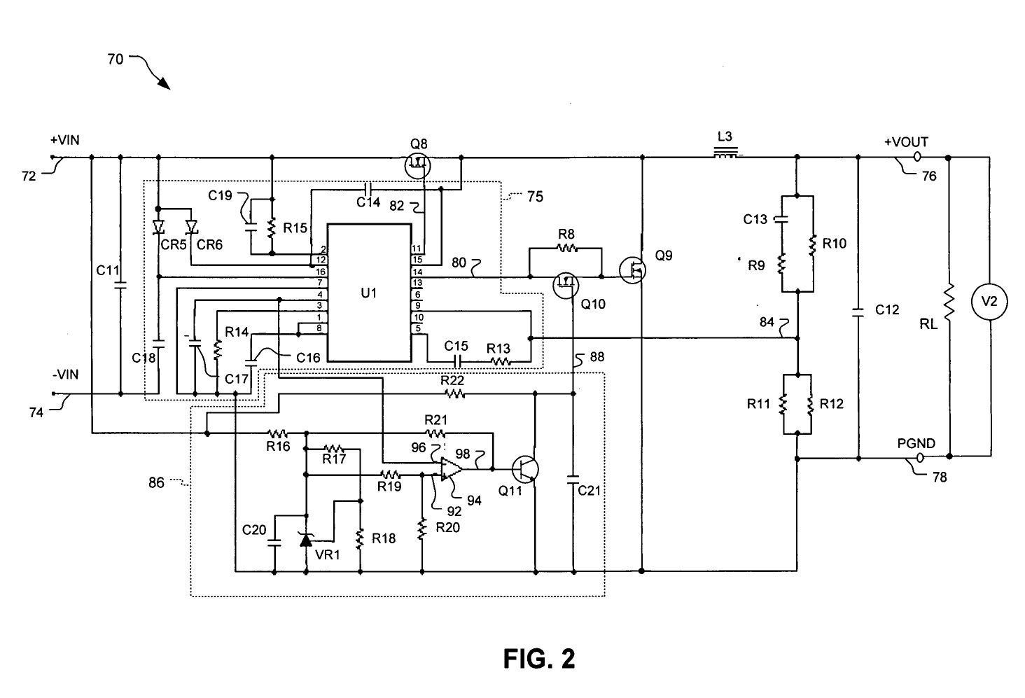

Turning now to FIG. 2, one of various embodiments of a buck converter 70 is shown. A +VIN 72 terminal and a −VIN 74 terminal provide an input to the converter 70. The +VIN 72 terminal is connected to one end of a capacitor C11 and to a drain of a transistor switch Q8. The other end of the capacitor C11 is connected to −VIN 74. A source of the transistor switch Q8 is connected to a synchronous buck control circuit 75, to one end of an inductor L3, and to a drain of a free-wheeling switch Q9. The other end of the inductor L3 is connected to a positive output voltage node +VOUT 76 and to one end of a capacitor C12. The other end of the capacitor C12 is connected to a power ground node PGND 78. A source of the free-wheeling switch Q9 is connected to PGND 78. A gate of the free-wheeling switch is connected through a resistor R8 to a low drive signal 80 of the control circuit 75. A transistor switch has a source connected to the gate of the free-wheeling switch Q9 and a drain connected to the low drive signal 80. A gate of the transistor switch Q8 is connected to a high drive signal 82 of the control circuit 75. One end of a capacitor C13 is connected to +VOUT 76 and to one end of a resistor R10. The other end of the capacitor C13 is connected to one end of a resistor R9. The other end of the resistor R9 is connected to the other end of the resistor R10 and to a feedback node 84. The feedback node 84 is connected to PGND 78 through parallel connected resistors R11 and R12.

The control circuit 75 may be provided by an integrated circuit IC1. In some embodiments an L6910 controller from STMicroelectronics is used, however other devices may also be used and the control circuit 75 modified accordingly. A capacitor C14 is connected between pin 12 of the circuit IC1 and the source of the switching transistor 08. The source of the switching transistor Q8 is also connected to pin 15 of the circuit IC1. The high drive signal 82 is provided by pin 11 of the circuit IC1. The low drive signal 80 is provided by pin 14 of the circuit IC1. The feedback node 84 is connected to pin 9 of the circuit IC1. Pin 9 is also connected to one end of a resistor R13. The other end of the resistor R13 is connected through a capacitor C15 to pin 5 of the circuit IC1. Pins 1 and 8 of the circuit IC1 are connected together and AC coupled to PGND 78 through a capacitor C16. Pin 3 of the circuit IC1 is connected to PGND 78 through a resistor R14. Pin 4 of the circuit IC1 is coupled to PGND 78 through a capacitor C17. Pin 7 of the circuit IC1 is connected to PGND 78. A rectifier CR5 and a rectifier CR6 have cathodes connected together and to +VIN 72. An anode of the rectifier CR5 is connected to pin 16 of the circuit IC1 and to one end of a capacitor C18. The other end of the capacitor C18 is connected to −VIN 74. An anode of the rectifier CR6 is connected pin 12 of the circuit IC1. A capacitor C19 and a resistor R15 are connected in parallel between +VIN 72 and pin 2 of the circuit IC1.

A gate control circuit 86 provides a gate control signal 88 to a gate of the switching transistor Q10. The gate control circuit 86 has a resistor with one end connected to +VIN 72 and the other end connected to a capacitor C20. The other end of the capacitor C20 is connected to PGND 78. A programmable voltage reference VR1 has a cathode connected to the junction of the resistor R16 and the capacitor C20, and to one end of a resistor R17. The other end of the resistor R17 is connected to one end of a resistor R18. The other end of the resistor R18 is connected to PGND 78. The resistors R17 and R18 form a voltage divider having a tap that provides a reference signal 90 for the voltage reference VR1. A resistor R19 has one end connected to the cathode of the voltage reference VR1. The other end of the resistor R19 is connected to a non-inverting input 92 of the comparator 94 and to one end of a resistor R20. The other end of the resistor R20 is connected to PGND 78. An inverting input 96 of the comparator 94 is connected to pin 4 of the circuit IC1. An output 98 of the comparator 94 is pulled up to the cathode voltage of the voltage reference VR1 by a resistor R21. The output 98 is also connected to a base of a switching transistor Q11. A collector of the switching transistor Q11 is pulled up to +VIN 72 by a resistor R22 and provides the gate control signal 88. An emitter of the switching transistor Q11 is connected to PGND 78. A capacitor C21 is connected between the gate control signal 88 and PGND 78.

Operation of the circuit if FIG. 2 will now be described. The capacitor C11 filters +VIN 72 that provides power to buck control circuit 75, the transistor switch Q8, and the gate control circuit 86. The transistor switch Q8 switches on and off in accordance with the high drive signal 82. The buck control circuit 75 controls a duty cycle of the high drive signal 82 according to a feedback signal at the feedback node 84. As transistor switch Q8 is turned on and off, it applies a PWM waveform to the inductor L3. The inductor L3 and the capacitor C12 filter the PWM waveform to provide +VOUT 76.

When the transistor switch Q8 is turned off, the free-wheeling switch Q9 may be turned on hard if the switching transistor Q10 is turned on, or partially turned on if the switching transistor Q10 is turned off. The switching transistor Q10 is turned off during a predetermined time beginning when power is applied to +VIN72. When the free-wheeling switch Q9 is partially turned on during the predetermined period, it is prevented from undesirably shorting +VOUT 76 to PGND 78 through the inductor L3. the switching transistor Q10 is turned on after the predetermined period because the inductor L3 then accumulates sufficient energy to prevent shorting +VOUT 76 to PGND 78. Transient perturbations of +VOUT 76 are thereby prevented during the predetermined period.

Operation of the gate control circuit 86 will be now be described. The resistors R16-R20, the capacitor C20, and a second signal applied to the inverting input 96 establish the predetermined period. The second signal can be provided by the buck control circuit 75. A first signal is applied to the non-inverting input 92. The resistor R16 and the capacitor C20 form an RC timer that originates the first signal. A resistor divider formed by the resistors R19 and R20 reduces the voltage from the RC timer and applies the first signal to the non-inverting input 92. The programmable voltage reference VR1 establishes a peak voltage for the first signal. Values of the resistors R16-R20 and the capacitor C20 are chosen such that the second signal rises faster than the first signal. In an example embodiment, the second signal rises two times faster than the first signal.

During the predetermined period after application of +VIN, the voltage of the non-inverting input 92 exceeds the voltage of the inverting input 96 and causes the output 98 of the comparator 94 to be high. With the output 98 high, the transistor switch Q11 is turned on and pulling the gate of the switching transistor Q10 down to PGND 78. The switching transistor Q10 is therefore turned off. After the predetermined period, the voltage of the inverting input 96 exceeds the voltage of the non-inverting input 92 and causes the output 98 to go low and turn off the transistor switch Q11. The switching transistor Q10 is then turned on because its gate is pulled up to +VIN 72 through the resistor R22. The free-wheeling switch Q9 therefore operates efficiently after the predetermined period since its gate may be quickly charged and discharged through the switching transistor Q10.

Turning now to FIG. 4, one of various embodiments of a gate control circuit 100 is shown. A first control circuit 102 provides a first control signal 104 to a first switch 106 and a second control signal 108 to a control input of a free-wheeling transistor Q13. The first control circuit 102 can turn on the free-wheeling transistor Q13 when it turns off the first switch 106.

A second control circuit 110 provides a gate control signal 112 that opens and closes a second switch 114. In some embodiments, the second control circuit 110 is a timer that opens the second switch 114 for a predetermined time beginning when power is applied to an input 116. In some embodiments, the second control circuit 110 closes the second switch 114 after the predetermined amount of time. When the second switch 114 is open, the second control signal 108 passes through a current limiting device, such as a resistor R23. The current limiting device limits an input current to the free-wheeling transistor Q13 and causes the free-wheeling transistor Q13 to operate in a linear mode when it is turned on. When the second switch 114 is closed, the second signal bypasses the current limiting device and the free-wheeling transistor Q13 operates in a saturation mode when it is turned on. A rectifier CR7 can have an anode connected to the control input of the free-wheeling transistor Q13 and a cathode connected to the first control circuit 102. The rectifier CR7 provides a discharge path for the control input of the free-wheeling transistor Q13 so that it can turn off quickly when the second switch 114 is open.

An inductor 118 is connected between an output node 120 and the free-wheeling transistor Q13. During the predetermined time, the inductor 118 approximates a short circuit. By operating the free-wheeling transistor Q13 in the linear mode during the predetermined time, the gate control circuit 100 reduces a risk of momentarily shorting the output node 120 to ground 122 through the inductor 118.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A circuit that controls a control signal of a free-wheeling switch, comprising:
a switch in series with the control signal; and
a timer having an output that controls the switch, wherein the timer opens the switch for a predetermined time and closes the switch after the predetermined time.

2. The circuit of claim 1 further comprising a current limiting device in parallel with the switch.

3. The circuit of claim 2 wherein the current limiting device comprises a resistor.

4. The circuit of claim 1 wherein the timer further comprises a first timer operating at a first rate and a second timer operating at a second rate, wherein the predetermined time is determined by comparing the first timer and the second timer.

5. The circuit of claim 1 wherein the timer comprises a first signal having a first rise time and second signal having a second rise time, wherein the predetermined time is determined by comparing the first signal and the second signal.

6. The circuit of claim 1 wherein the timer comprises an RC timer.

7. The circuit of claim 1 wherein the timer comprises a comparator having an output that opens and closes the switch.

8. The circuit of claim 1 wherein the predetermined time begins upon power being applied to the circuit.

9. A free-wheeling switch circuit for a synchronous switching power supply having an input and a pre-biased output, comprising:
an inductor;
a first switch connected to the inductor and having a first control input;
a first control signal source;
a second switch having a second control input and being connected between the first control signal source and the first control input; and
a control circuit having an output in communication with the second control input, the control circuit opening the second switch for a predetermined time after applying power to the input of the power supply and closing the second switch after the predetermined time.

10. The circuit of claim 9 further comprising a means for operating the first switch in a linear mode during the predetermined time.

11. The circuit of claim 9 wherein the control circuit further comprises a first timer operating at a first rate and a second timer operating at a second rate, wherein the predetermined time is determined by comparing the first timer and the second timer.

12. The circuit of claim 9 wherein the control circuit comprises a first signal having a first rise time and second signal having a second rise time, wherein the predetermined time is determined by comparing the first signal and the second signal.

13. The circuit of claim 9 wherein the control circuit comprises a timer means.

14. The circuit of claim 9 wherein the control circuit comprises a comparator having an output that opens and closes the second switch.

15. A method for driving a gate of a free-wheeling switch in a switching power supply, comprising:
generating a control signal;
operating the free-wheeling switch in a first mode when the control signal turns on the free-wheeling switch during a predetermined period; and
operating the free-wheeling switch in a second mode when the control signal turns on the free-wheeling switch after the predetermined period.

16. The method of claim 15 further comprising a step of initiating the predetermined period upon applying power to the switching power supply.

17. The method of claim 15 wherein the step of operating the free-wheeling switch in a first mode further comprises limiting current of the control signal.

18. The method of claim 17 further comprising the steps of generating a first timing signal;
generating a second timing signal;
comparing the first timing signal and the second timing signal to determine the predetermined time.

19. The method of claim 15 wherein the first mode is a linear mode and the second mode is a saturated mode.
